(19) United States
(12) Patent Application Publication
(10) Pub. No.: US 2017/0075747 A1
(43) Pub. Date: Mar. 16, 2017

(54) MANAGEMENT APPARATUS, MANAGEMENT METHOD, AND COMPUTER-READABLE RECORDING MEDIUM

(71) Applicant: FUJITSU LIMITED, Kawasaki-shi (JP)

(72) Inventors: Tadahiro KAGEYAMA, Kawasaki (JP); Koyo Miyagi, Ota (JP); Hideki Sakurai, Kawasaki (JP); Masanori Kimura, Mishima (JP); Kei Ohishi, Chigasaki (JP)

(73) Assignee: FUJITSU LIMITED, Kawasaki-shi (JP)

(21) Appl. No.: 15/248,559

(22) Filed: Aug. 26, 2016

(30) Foreign Application Priority Data
Sep. 14, 2015 (JP) 2015-181174

(51) Int. Cl. G06F 11/07

(52) U.S. Cl. CPC G06F 11/079; G06F 11/0709; G06F 11/0751; G06F 11/0772; G06F 11/0769

(57) ABSTRACT

A control server includes a memory that stores therein configuration information on a system that operates in each of data centers. The control server specifies, from the information stored in the memory, a data center having configuration information on the system that meets a condition under which a failure occurs. Thereafter, the control server transmits failure information relating to the failure to a notification destination of the specified data center that meets the condition under which a failure occurs.

### CROSS-REFERENCE TO RELATED APPLICATION

This application is based upon and claims the benefit of priority of the prior Japanese Patent Application No. 2015-181174, filed on Sep. 14, 2015, the entire contents of which are incorporated herein by reference.

### FIELD

The embodiments discussed herein are related to a management apparatus, a management method, and a computer-readable recording medium having stored therein a management program.

### BACKGROUND

In recent years, with the widespread use of a virtual machine or the like, outsourcing services that provide services by using a plurality of data centers without limiting regions and countries are increasingly used. For example, an outsourcing service uniformly provides service management, operation, service platforms, facilities, and networks without geographical constraints and physical constraints, under a unified concept and standardized service management.

Furthermore, the outsourcing service is configured with a plurality of data centers, so that the number of information equipments and systems to be operated is enormous. Therefore, in general, a responsible engineer is assigned to each system, and each system is separately managed.

Patent Literature 1: Japanese National Publication of International Patent Application No. 2006-520975

Patent Literature 2: Japanese Laid-open Patent Publication No. 2006-244373

However, in the above-described conventional technologies, burdens on the responsible engineers are high, so that failure detection or troubleshooting may be omitted or delayed, and the reliability of the system may be reduced. For example, each vendor that develops hardware or software releases failure information as needed, but the frequency and coverage of checking the failure information vary among the responsible engineers. Furthermore, the responsible engineers detect a failure by comparing the released failure information and configuration information on the system, but operational burdens on the responsible engineers are increased with an increase in hardware and software in the system.

### SUMMARY

According to an aspect of an embodiment, a management apparatus includes a memory that stores therein configuration information on a system that operates in each of data centers; and a processor that is connected to the memory, wherein the processor executes a process. The process includes specifying, from the memory, a data center having configuration information on the system that meets a condition under which a failure occurs; and transmitting failure information relating to the failure to a notification destination of the data center specified at the specifying.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration of a system according to a first embodiment;

FIG. 2 is a functional block diagram illustrating a functional configuration of the system according to the first embodiment;

FIG. 3 is a diagram illustrating an example of information stored in a failure master DB;

FIG. 4 is a diagram illustrating an example of information stored in a customer master DB;

FIG. 5 is a diagram illustrating an example of information stored in a center master DB;

FIG. 6 is a diagram illustrating an example of information stored in a condition master DB;

FIG. 7 is a diagram illustrating an example of information stored in a configuration DB;

FIG. 8 is a diagram for explaining an example of notification to a user;

FIG. 9 is a flowchart illustrating the flow of a process at the time of updating a failure;

FIG. 10 is a flowchart illustrating the flow of a process at the time of updating a configuration;

FIG. 11 is a flowchart illustrating the flow of a process of determining notification of failure information;

and

FIG. 12 is a diagram illustrating an example of a hardware configuration.

### DESCRIPTION OF EMBODIMENTS

Preferred embodiments will be explained with reference to accompanying drawings. The present invention is not limited by the embodiments. Furthermore, the embodiments may appropriately be combined as long as no contradiction is derived.

### [a] First Embodiment

### Overall Configuration

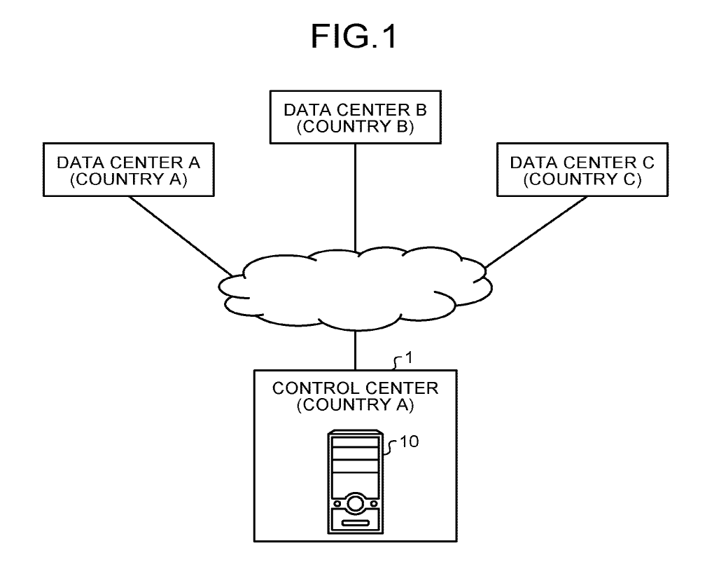

FIG. 1 is a diagram illustrating an example of an overall configuration of a system according to a first embodiment. As illustrated in FIG. 1, the system includes a control center 1, a data center A, a data center B, and a data center C.

Each of the data centers is a data center (hereinafter, may be described as a DC) in which a physical server is set, and which provides functions of various servers, such as a Web server, a database (DB) server, or an AP server, by the physical server or a virtual machine, and provides an operation system. The control center 1 is a data center, in which a control server 10 is installed and which manages information on each of the data centers and information on a customer who uses each of the data centers.

Furthermore, the data center A is installed in a country A, the data center B is installed in a country B, the data center C is installed in a country C, and the control center 1 is installed in the country A. That is, in the example in FIG. 1, the data center A and the control center 1 are installed in the same country and the other data centers are installed in different countries.

In this state, the control server 10 of the control center 1 stores therein configuration information on a system that operates in each of the data centers. Then, the control server 10 specifies a data center having the configuration information on a system that meets a condition under which a failure occurs. Thereafter, the control server 10 transmits failure information on the failure to the specified data center.

That is, the control server 10 specifies a DC that has a system configuration that matches a failure condition among management target DCs, and distributes the failure information to the specified DC. By this operation, it is possible to reduce a load related to failure detection performed by a responsible engineer in each of the DCs, enabling to reduce man-caused mistake, such as oversight in a failure, and improve the reliability of the system.

Functional Configuration

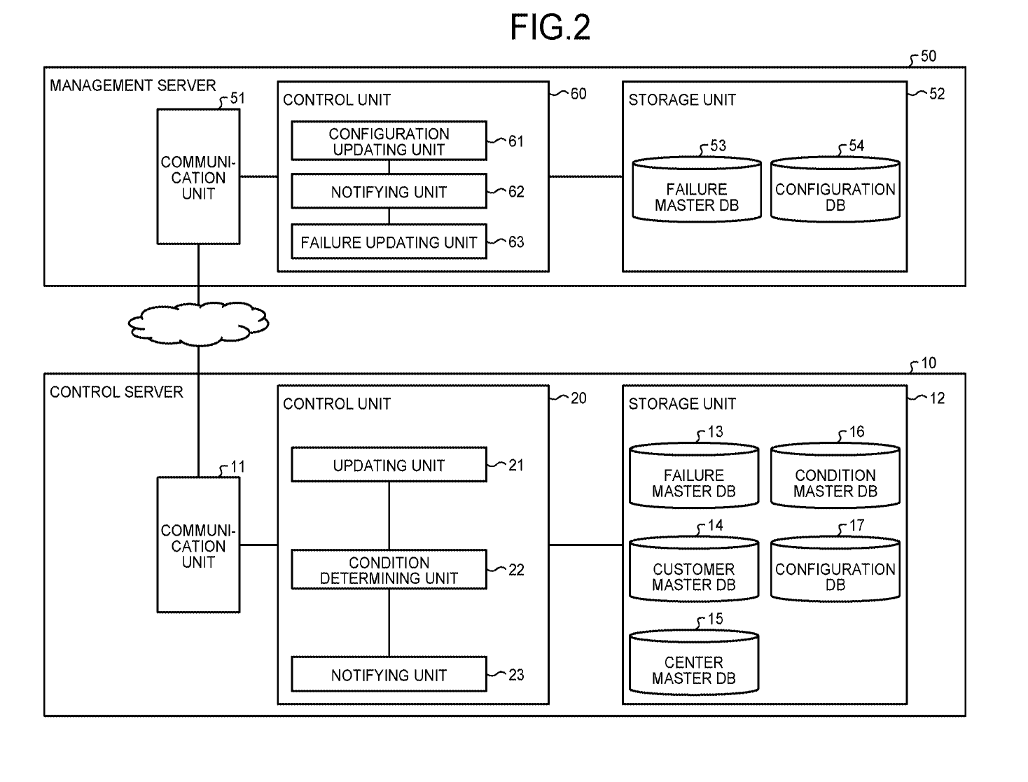

Next, the control server 10 of the control center 1 and a management server installed in each of the data centers illustrated in FIG. 1 will be described. Incidentally, the management servers installed in the respective data centers have the same configuration, and therefore will be described as a management server 50 below. FIG. 2 is a functional block diagram illustrating a functional configuration of the system according to the first embodiment.

Configuration of the Control Server 10

As illustrated in FIG. 2, the control server 10 includes a communication unit 11, a storage unit 12, and a control unit 20.

The communication unit 11 is a communication interface that controls communication with other devices, regardless of whether it is wired or wireless. For example, the communication unit 11 receives failure information including information on a system configuration in which a failure may occur, a priority of the failure, or the like from an administrator terminal or each vendor. Furthermore, the communication unit 11 transmits the failure information to the management server 50 in each of the DCs.

The storage unit 12 is a database for storing data and a program executed by the control unit 20, and is, for example, a hard disk, a memory, or the like. The storage unit 12 stores therein a failure master DB 13, a customer master DB 14, a center master DB 15, a condition master DB 16, and a configuration DB 17.

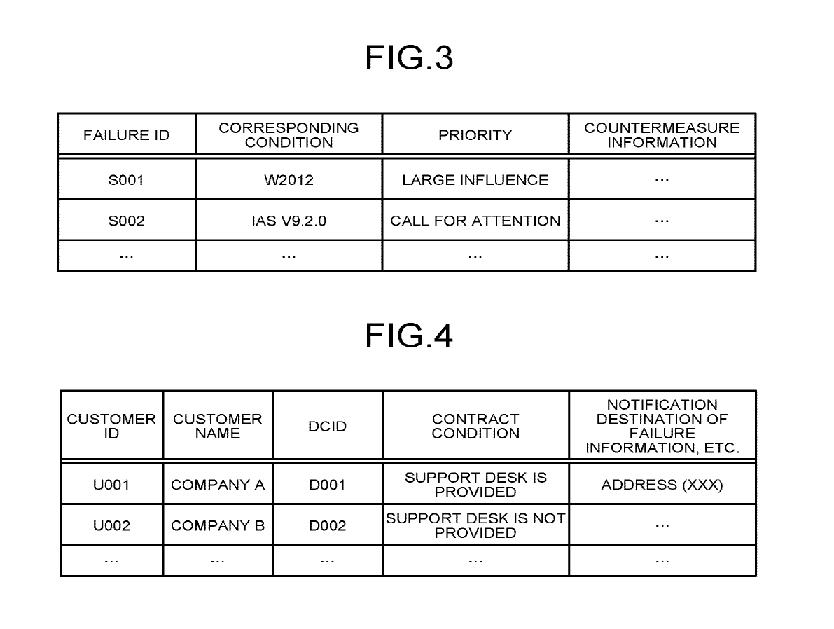

The failure master DB 13 is a database for storing failure information including a condition under which a failure occurs, a priority of the failure, and the like. FIG. 3 is a diagram illustrating an example of information stored in the failure master DB 13. As illustrated in FIG. 3, the failure master DB 13 stores therein “a failure ID, a corresponding condition, a priority, and countermeasure information” in an associated manner.

The “failure ID” stored here is an identifier for uniquely identifying a failure. The “corresponding condition” is configuration information on a system in which a failure occurs, and is, for example, a type of an operating system (OS), a version of the OS, a type of hardware (HW), a version of the HW, a type of software (SW), a version of the SW, a type of middle ware (MW), a version of the MW, and the like. The “priority” is information indicating the degree of influence of a failure, and is set to a large influence, a call for attention, a notification level, or the like. The “countermeasure information” is information on troubleshooting notified by a vendor or the like, and is set to, for example, patch application, removal of an XXX file, reinstallation, or the like.

In the example in FIG. 3, it is indicated that a failure “S001”, for which a “large influence” is set as the priority, will occur in an OS “W2012”. Furthermore, it is indicated that a failure “S002”, for which a “call for attention” is set as the priority, will occur in MW “IAS” of a version “V9.2.0”.

The customer master DB 14 is a database for storing information on a customer who uses a DC. FIG. 4 is a diagram illustrating an example of the information stored in the customer master DB 14. As illustrated in FIG. 4, the customer master DB 14 stores therein “a customer ID, a customer name, a DCID, a contract condition, and a notification destination of failure information or the like” in an associated manner.

The “customer ID” stored here is an identifier for identifying a customer. The “customer name” is a name of the customer. The “DCID” is an identifier for identifying a DC used by the customer. The “contract condition” is a contract condition signed between a company that operates the DC and the customer. The “notification destination of failure information or the like” is address information on an administrator or the like.

In the example in FIG. 4, it is indicated that “U001” is assigned to a “company A” and the company A is using a DC “D001” under the condition that a “support desk is provided”. Furthermore, it is indicated that “U002” is assigned to a “company B” and the company B is using a DC “D002” under the condition that a “support desk is not provided”. Moreover, it is indicated that a notification destination of an administrator of the company A is an address (XXX).

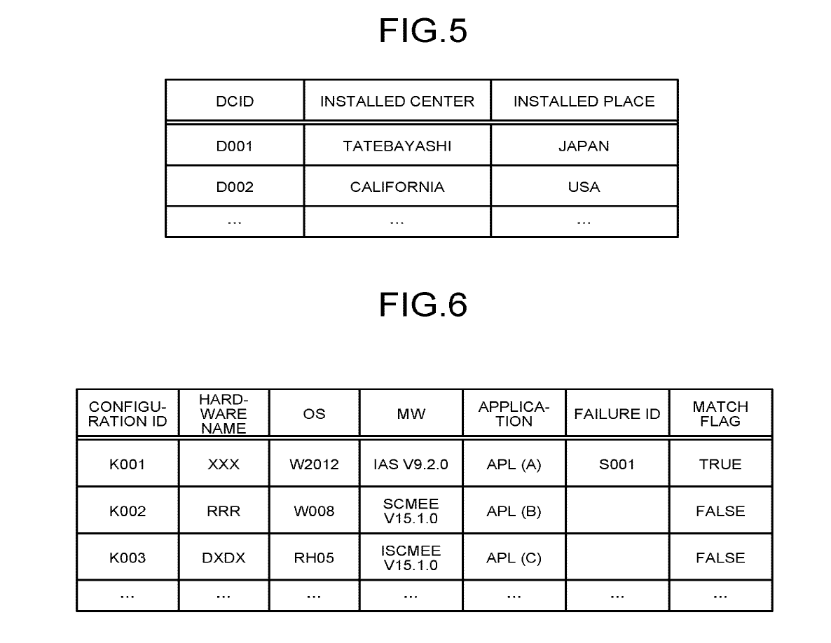

The center master DB 15 is a database for storing information on an installed place of each of the DCs or the like. FIG. 5 is a diagram illustrating an example of the information stored in the center master DB 15. As illustrated in FIG. 5, the center master DB 15 stores therein “a DCID, an installed center, and an installed place” in an associated manner.

The “DCID” stored here is an identifier for identifying a DC. The “installed center” indicates a region in which the DC is installed. The “installed place” indicates a country in which the DC is installed. In the example in FIG. 5, it is indicated that a DC “D001” is installed in “Tatebayashi” in “Japan”, and a DC “D002” is installed in “California” in “the United States of America”.

The condition master DB 16 is a database for storing information that is used to determine whether a system configuration conforms to the failure information. FIG. 6 is a diagram illustrating an example of information stored in the condition master DB 16. As illustrated in FIG. 6, the condition master DB 16 stores therein “a configuration ID, a hardware name, an OS, MW, an application, a failure ID, and a match flag” in an associated manner.

The “configuration ID” stored here is an identifier for identifying a system configuration. The “hardware name” is a name of hardware included in the system. The “OS” is a name of an OS used in the system. The “MW” is information on middleware used in the system. The “application” is information on an application that runs on the system. The “failure ID” is an identifier of failure information that matches the system configuration. The “match flag” is information indicating whether the system configuration matches any of the failure information.

In the example in FIG. 6, a system configuration “K001” includes hardware “XXX”, an OS “W2012”, and middleware “IAS V9.2.0”. Furthermore, in the system configuration “K001”, “APL (A)” operates as an application. Moreover, it is indicated that the system configuration “K001” matches the failure information “S001”.

Furthermore, a system configuration “K002” includes hardware “RRR”, an OS “W008”, and middleware “SCMEE V15.1.0”. Moreover, in the system configuration “K002”, “APL (B)” operates as an application. Furthermore, it is indicated that the system configuration “K001” does not match any failure information.

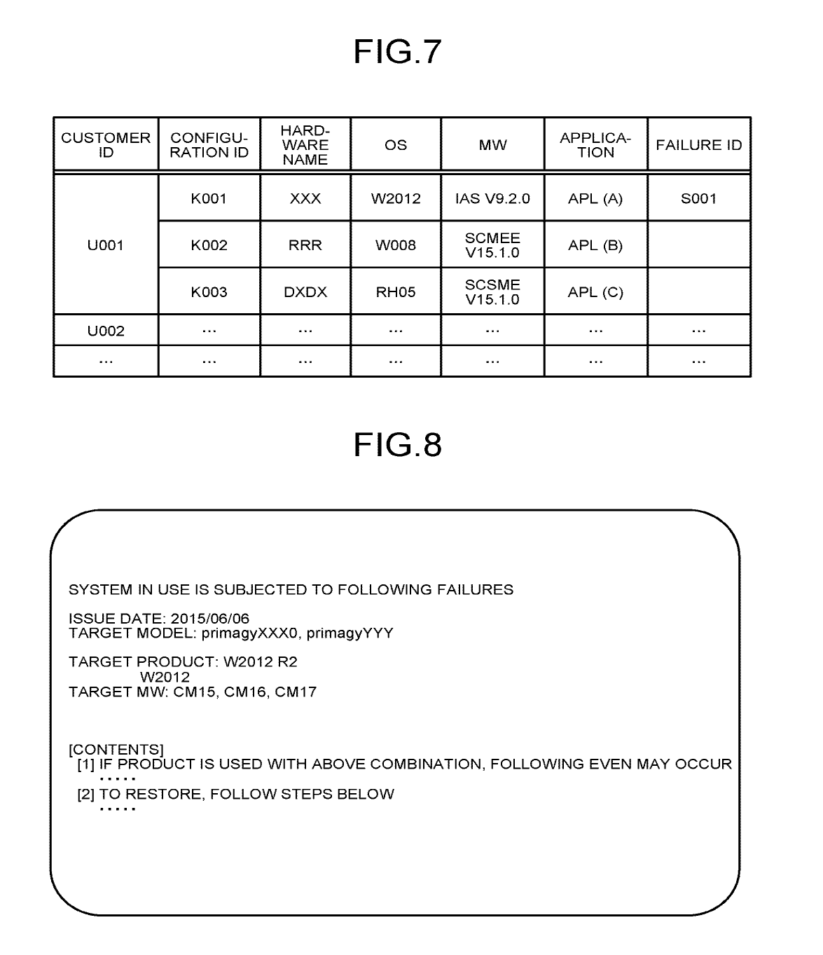

The configuration DB 17 is a database for storing configuration information on a system used by a customer, for each customer. FIG. 7 is a diagram illustrating an example of information stored in the configuration DB 17. As illustrated in FIG. 7, the configuration DB 17 stores therein “a customer ID, a configuration ID, a hardware name, an OS, MW, an application, and a failure ID” in an associated manner. The pieces of the information stored here are already described above, and therefore, detailed explanation thereof will be omitted.

In the example in FIG. 7, a customer “U001” has three system configurations “K001”, “K002”, “K003”. Of the three system configurations, the system configuration “K001” includes hardware “XXX”, an OS “W2012”, and middleware “IAS V9.2.0”. Furthermore, in the system configuration “K001”, “APL (A)” operates as an application. Moreover, it is indicated that the system configuration “K001” matches the failure information “S001”.

The control unit 20 is a processing unit that controls the entire control server 10, and is, for example, a processor or the like. The control unit 20 includes an updating unit 21, a condition determining unit 22, and a notifying unit 23. Incidentally, the updating unit 21, the condition determining unit 22, and the notifying unit 23 are examples of an electronic circuit included in the processor, or a process executed by the processor.

The updating unit 21 is a processing unit that updates the failure master DB 13 in accordance with the failure information. Specifically, the updating unit 21 acquires the failure information including information on a system configuration in which a failure may occur, a priority of the failure, or the like from an administrator terminal or each vendor, and stores the failure information in the failure master DB 13. Then, the updating unit 21 notifies the condition determining unit 22 that the failure master DB 13 is updated.

For example, the updating unit 21 extracts a system configuration in which a failure may occur, a priority indicating the degree of hazard or the like of the failure, countermeasure information, and the like from the acquired failure information. Then, the updating unit 21 generates a new record to which a new failure ID is assigned in the failure master DB 13, stores the extracted system configuration in the “corresponding condition” of the record, stores the extracted priority in the “priority”, and stores the extracted countermeasure information in the “countermeasure information”.

Furthermore, the updating unit 21 is a processing unit that updates the configuration DB 17 in response to a notification from each of the DCs. Specifically, when receiving new configuration information on the configuration ID “K001” of the customer ID “U001” from the data center A, the updating unit 21 updates the configuration DB 17 and the condition master DB 16 with the received information. Then, the updating unit 21 notifies the condition determining unit 22 that the configuration DB 17 and the condition master DB 16 are updated.

The condition determining unit 22 is a processing unit that specifies a data center with the configuration information on a system that meets a condition under which a failure occurs. Specifically, if the updating unit 21 updates the failure master DB 13, the condition determining unit 22 reads the updated corresponding condition from the failure master DB 13. Then, the condition determining unit 22 compares the read corresponding condition and each record stored in the condition master DB 16, and sets a match flag in the condition master DB 16.

For example, the condition determining unit 22 detects a configuration ID that meets the corresponding condition of a failure, and if “TRUE” is already set in the “match flag” of the configuration ID, the condition determining unit 22 newly adds a failure ID of the corresponding condition. Furthermore, the condition determining unit 22 detects a configuration ID that meets the corresponding condition of a failure, and if “FALSE” is set in the “match flag” of the configuration ID, the condition determining unit 22 rewrites the “match flag” with “TRUE” and newly adds a failure ID of the corresponding condition.

Incidentally, the condition determining unit 22 determines whether the corresponding condition is satisfied in accordance with a condition set in advance. For example, the condition determining unit 22 may determine a configuration ID that matches all of the hardware name, the OS, the MW, and the application included in the corresponding condition, as a system configuration that meets the corresponding condition. Furthermore, the condition determining unit 22 may determine a configuration ID that matches a predetermined pair among the hardware name, the OS, the MW, and the application included in the corresponding condition, as a system configuration that meets the corresponding condition.

Moreover, the condition determining unit 22 may dynamically change the number of items to be determined or the like, in accordance with the priority of the corresponding condition. For example, if the priority is set to a “large influence” indicating the highest emergency, the condition determining unit 22 may determine that the corresponding condition is satisfied when any of the hardware name, the OS, the MW, and the application matches that of the configuration ID. This is to minimize the influence of the failure. Furthermore, in the case of the lowest priority, the condition determining unit 22 determines that the corresponding condition is satisfied when all of the hardware name, the OS, the MW, and the application match those of the configuration ID. This is to reduce unnecessary operations, such as a change in the system configuration or a countermeasure against a failure, by notifying the failure information with the small influence.

Furthermore, if the updating unit 21 updates the configuration DB 17 and the condition master DB 16, the condition determining unit 22 may compare each of the corresponding conditions stored in the failure master DB 13 and each of the records stored in the condition master DB 16, and may set the match flag in the condition master DB 16. In this case, the condition determining unit 22 may perform determination on only the changed configuration ID.

The notifying unit 23 is a processing unit that transmits the failure information on a failure to a data center that is specified, by the condition determining unit 22, as a data center that meets a condition under which a failure occurs. Specifically, the notifying unit 23 monitors the condition master DB 16, and detects a configuration ID for which the match flag is updated with “TRUE” or a configuration ID for which a failure ID is added. Then, the notifying unit 23 searches through the configuration DB 17 by using the detected configuration ID as a key, and provides a failure ID of new failure information in the failure ID of the corresponding configuration ID.

Furthermore, the notifying unit 23 specifies a customer ID associated with the configuration ID specified from the configuration DB 17, searches through the customer master DB 14 by using the customer ID as a key, and specifies a corresponding DCID. Then, the notifying unit 23 extracts failure information corresponding to the failure ID from the failure master DB 13, and transmits the failure information to the management server 50 with the specified DCID. In this case, the notifying unit 23 may transmit the failure information to a notification destination of a customer when a “support desk is provided” is set in the contract condition of the customer, and may prevent transmission of the failure information to the notification destination of the customer when a “support desk is not provided” is set in the contract condition of the customer.

Incidentally, it is assumed that an e-mail address, an apparatus address (an Internet Protocol (IP) address or a Media Access Control (MAC) address), or the like, which is set in advance as a notification destination of each of the management servers, is stored in advance. Furthermore, it is assumed that an e-mail address, an apparatus address, or the like, which is set in advance as a notification destination of a customer, is also stored in advance. In the case of the apparatus address of each of the management servers, it may be possible to send a notification to a notification destination of an administrator (an e-mail address, an apparatus address, or the like set in advance) via the management server. Furthermore, in the case of the apparatus address, it may be possible to transmit failure information including a command to display the content of a failure on a display device of an apparatus.

As one example, an example will be described in which the “match flag” of the configuration ID “K002” is changed from “FALSE” to “TRUE” because of the failure ID “S002”. That is, it is assumed that the system configuration “K002” meets the corresponding condition of the failure ID “S002”.

In this case, the notifying unit 23 adds “S002” to the failure ID of the configuration ID “K002” in the configuration DB 17. Subsequently, the notifying unit 23 refers to the configuration DB 17 and specifies the customer ID “U001” corresponding to the configuration ID “K002”. Thereafter, the notifying unit 23 refers to the customer master DB 14, and determines to send a notice of the failure information because a “support desk is provided” is set in the contract condition of the customer ID “U001”.

Then, the notifying unit 23 refers to the customer master DB 14 and specifies a DCID “D001” of the customer ID “U001”. Furthermore, the notifying unit 23 extracts “corresponding condition, priority, and countermeasure information” corresponding to the failure ID “S002” from the failure master DB 13. Thereafter, the notifying unit 23 transmits the extracted “corresponding condition, priority, and countermeasure information” as the failure information to the management server 50 with the DCID “D001”.

Configuration of the Management Server 50

As illustrated in FIG. 2, the management server 50 includes a communication unit 51, a storage unit 52, and a control unit 60. The communication unit 51 is a communication interface that controls communication with other devices, regardless of whether the it is wired or wireless. For example, the communication unit 51 receives failure information from the control server 10 and transmits configuration information to the control server 10.

The storage unit 52 is a database for storing a program executed by the control unit 60 and data, and is, for example, a hard disk, a memory, or the like. The storage unit 52 stores therein a failure master DB 53 and a configuration DB 54.

The failure master DB 53 is a database for storing failure information including a condition under which a failure occurs, a priority of the failure, and the like. Incidentally, the information stored in the failure master DB 53 is the same as the information stored in the failure master DB 13, and therefore, detailed explanation thereof will be omitted.

The configuration DB 54 is a database for storing configuration information on a system used by a customer, for each customer who uses a DC in which the management server 50 is installed. Incidentally, the information stored in the configuration DB 54 is the same as the information stored in the configuration DB 17, and therefore, detailed explanation thereof will be omitted.

The control unit 60 is a processing unit that controls the entire management server 50, and is, for example, a processor or the like. The control unit 60 includes a configuration updating unit 61, a notifying unit 62, and a failure updating unit 63. Incidentally, the configuration updating unit 61, the notifying unit 62, and the failure updating unit 63 are examples of an electronic circuit included in the processor, or a process executed by the processor.

The configuration updating unit 61 is a processing unit that updates the configuration DB 54. Specifically, when SW, MW, or the like is newly installed, when SW, MW, or the like is deleted, or when an update patch is applied to SW, MW, or the like, the configuration updating unit 61 updates corresponding configuration information. Then, the configuration updating unit 61 notifies the notifying unit 62 that the configuration information is updated.

The notifying unit 62 is a processing unit that transmits the updated configuration information to the control server 10. Specifically, when the notifying unit 62 is notified, by the configuration updating unit 61, that the configuration ID “K001” is updated, the notifying unit 62 reads the configuration information on the configuration ID “K001” from the configuration DB 54 and transmits the configuration information to the control server 10. Furthermore, when the notifying unit 62 is notified, by the configuration updating unit 61, that the configuration information on the configuration ID “K011” is newly added, the notifying unit 62 reads the configuration information on the configuration ID “K011” from the configuration DB 54 and transmits the configuration information to the control server 10.

The failure updating unit 63 is a processing unit that updates the failure master DB 53 in accordance with the failure information received from the control server 10. For example, when receiving the failure information (the corresponding condition, the priority, and the countermeasure information) on the failure ID “S005” from the control server 10, the failure updating unit 63 adds the received failure information to the failure master DB 53.

Furthermore, when accepting input of the failure information (corresponding condition, priority, and countermeasure information) on the failure ID of “S006” from an administrator or the like, the failure updating unit 63 adds the accepted failure information to the failure master DB 53. Then, the failure updating unit 63 transmits the added failure information to the control server 10 and requests execution of determination on matching of the failure information.

Moreover, when adding new failure information to the failure master DB 53, the failure updating unit 63 may transmit a failure notice to a notification destination of an administrator, a customer, or the like. FIG. 8 is a diagram for explaining an example of notification. The failure updating unit 63 transmits a failure notice as illustrated in FIG. 8 for example or displays the failure notice on a display or the like. As illustrated in FIG. 8, the failure notice includes an “issue date” indicating a date on which the failure information is added, “target model, target product, and target MW” corresponding to the corresponding condition of the failure information, a “communication content” in which the countermeasure information or the like is described, and the like. Incidentally, the contents included in the failure notice may be changed appropriately.

Flow of a Process at the Time of Updating a Failure

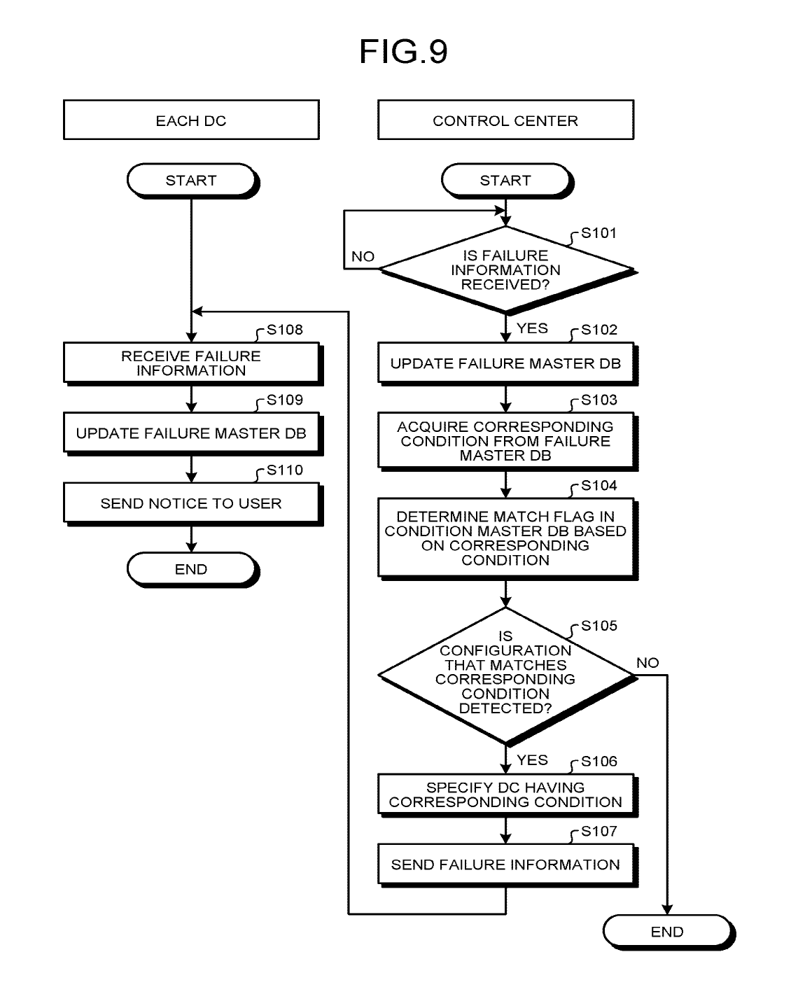

FIG. 9 is a flowchart illustrating the flow of a process at the time of updating a failure. As illustrated in FIG. 9, when the updating unit 21 of the control server 10 of the control center 1 receives the failure information (YES at S101), the updating unit 21 updates the failure master DB 13 (S102).

Subsequently, the condition determining unit 22 reads the corresponding condition from the failure master DB 13 (S103), and determines the match flag in the condition master DB 16 on the basis of the corresponding condition (S104). Then, if a system configuration that matches the corresponding condition is detected (YES at S105), the notifying unit 23 refers to each of the DBs, specifies a DC that has the corresponding system configuration (S106), and notifies the specified DC of the corresponding failure information (S107). Incidentally, the processes from S103 to S107 are performed for each corresponding condition stored in the failure master DB 13 and each configuration stored in the condition master DB 16.

Then, when receiving the failure information from the control server 10 (S108), the failure updating unit 63 of the management server 50 in each of the DCs updates the failure master DB 53 (S109). Thereafter, the failure updating unit 63 sends a notice of the failure information to a notification destination of a customer (S110).

Flow of a Process at the Time of Updating a Configuration

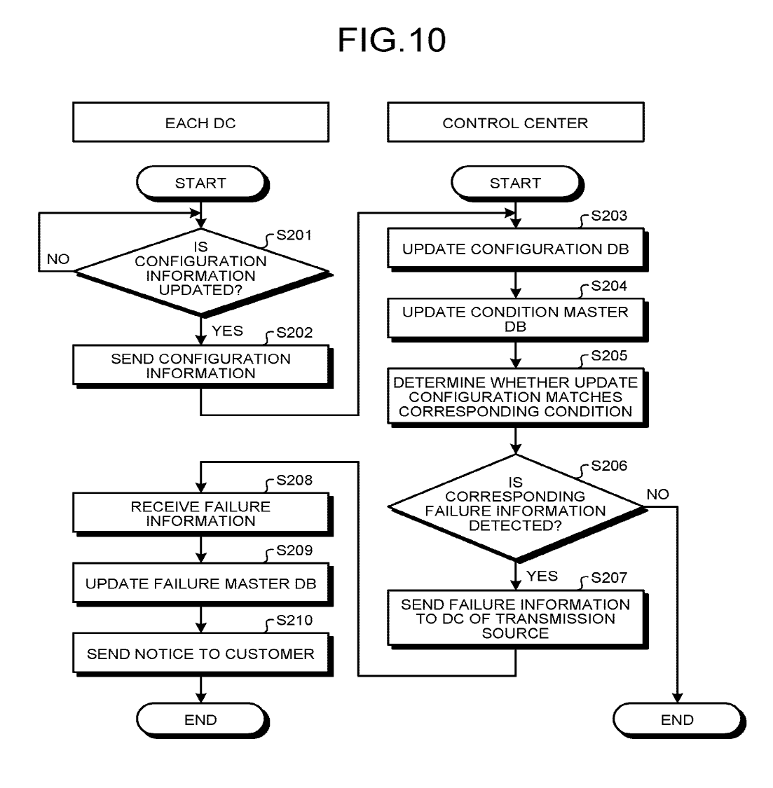

FIG. 10 is a flowchart illustrating the flow of a process at the time of updating a configuration. As illustrated in FIG. 10, when the configuration updating unit 61 of the management server 50 in each DC updates the configuration information stored in the configuration DB 54 (YES at S201), the configuration updating unit 61 transmits the configuration information that is the updated configuration information to the control server 10 (S202).

The updating unit 21 of the control server 10 that has received the updated information updates the configuration DB 17 by using the received updated information (S203). Furthermore, the updating unit 21 updates the condition master DB 16 in accordance with the update of the configuration DB 17 (S204). Thereafter, the condition determining unit 22 compares the updated system configuration and the failure master DB 13, and determines whether the system configuration matches the corresponding condition of the failure information (S205). Then, if the corresponding failure information is detected (YES at S206), the notifying unit 23 transmits the corresponding failure information to the DC of a transmission source (S207). At this time, the condition master DB 16 and the configuration DB 17 are also updated.

Then, when the failure updating unit 63 of the management server 50 in each of the DCs receives the failure information from the control server 10 (S208), the failure updating unit 63 updates the failure master DB 53 (S209). Thereafter, the failure updating unit 63 sends a notice of the failure information to a notification destination of a customer or the like (S210).

Effects

As described above, the control server 10 centrally manages conditions of a system in which a failure or a sign of a failure is detected, and sends a notice to a DC in which the corresponding system is installed. Consequently, it is possible to reduce load related to failure detection performed by a responsible engineer in each of the DCs. Therefore, it is possible to centrally manage the failure information and equalize the frequency and coverage of checking the failure information among the DCs. Consequently, it becomes possible to reduce man-caused mistake, such as oversight in a failure, and improve the reliability of the system.

### [b] Second Embodiment

In the first embodiment, an example has been described in which the failure information is notified regardless of regions or the like in which a DC is installed. However, the present invention is not limited to this example. For example, the management server 50 may take into account export control (i.e., export regulation) based on a treaty or the like. Therefore, in a second embodiment, notification control of the failure information will be described.

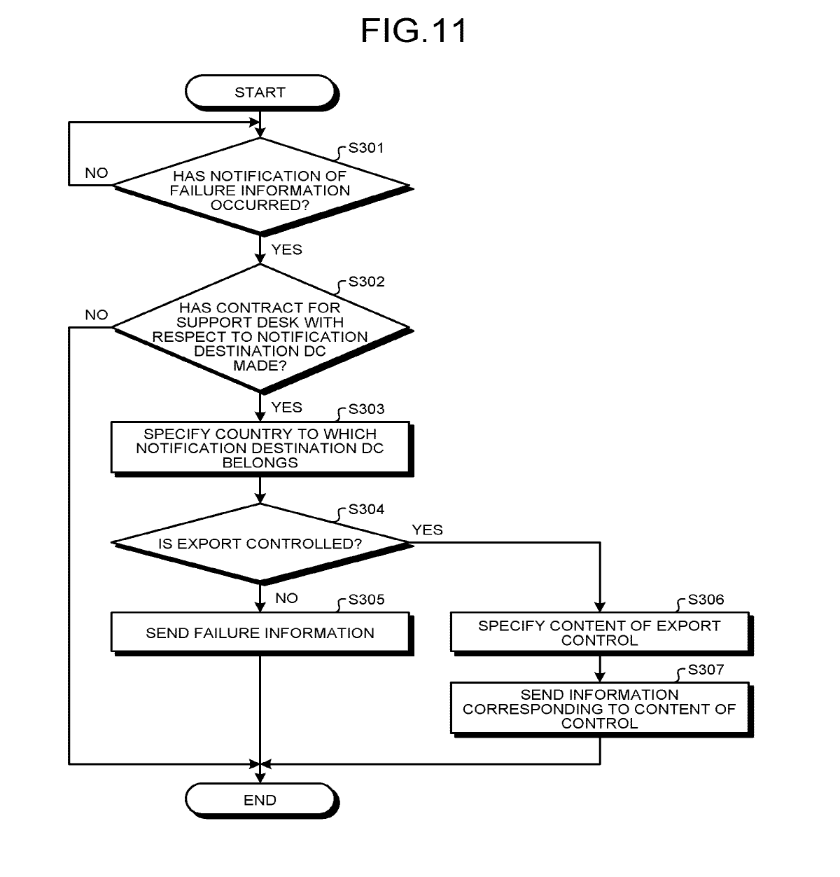

FIG. 11 is a flowchart illustrating the flow of a process of determining notification of failure information. Incidentally, determination of a failure is the same as that of the first embodiment, and therefore, explanation thereof will be omitted. As illustrated in FIG. 11, if notification of the failure information has occurred (YES at S301), the notifying unit 23 of the control server 10 determines whether a contract for a support desk with respect to a notification destination DC has been made. That is, the notifying unit 23 refers to the customer master DB 14 and determines whether a “support desk is provided” is set in the contract condition of a corresponding customer.

Then, if the contract for the support desk has been made (YES at S302), the notifying unit 23 refers to the center master DB 15 or the like, and specifies a country to which the notification destination DC belongs (S303). Subsequently, the notifying unit 23 refers to condition information or export control that is stored in the storage unit 12 or the like in advance, and determines whether export from the control center 1 to the specified country is controlled (S304).

If the export is not controlled (NO at S304), the notifying unit 23 transmits the failure information as it is to the management server 50 in the corresponding DC (S305). In contrast, if the export is controlled (YES at S304), the notifying unit 23 specifies a content of the export control or the like (S306), and sends a notice corresponding to the specified content of the control (S307).

For example, if all kinds of export are prohibited, the notifying unit 23 sends a notice of only occurrence of a failure, and does not send a notice of detailed information. Furthermore, if part of export, such as export of dangerous goods, is prohibited, the notifying unit 23 sends a notice except for information on a detailed system configuration or security hole to be used to generate a virus or the like.

Moreover, if a plurality of notification destinations are set for the corresponding DC, the notifying unit 23 sends a notice to only a notification destination associated with an administrator who is located in a country to which export is not controlled. Furthermore, if a plurality of notification destinations are set for the corresponding DC, the notifying unit 23 may send a notice of presence or absence of a failure to the management server 50 in a DC for which export is controlled, and may send the failure information to a notification destination associated with a customer (user) who is located in a country for which export is not controlled among customers (users) using the corresponding DC.

While a country in which the DC is installed is described as an example, the present invention is not limited to this example. For example, it may be possible to control notification information in accordance with regulations, conditions, or the like applied in regions, special economic zones, or various special zones, for each of the regions, the special economic zones, and the various special zones.

As described above, even when the control server 10 centrally manages DCs installed in all over the world, it is possible to perform operations in accordance with laws and regulations, such as treaties, and improve the reliability of the system.

### [c] Third Embodiment

While the embodiments of the present invention have been described above, the present invention may be embodied in various different forms other than the above-described embodiments.

Trigger of Update

In the first embodiment, an example has been described in which the control server 10 updates the failure information and the management server 50 updates the configuration information; however, the present invention is not limited to this example. For example, when the control server 10 updates the configuration information, the same process as the first embodiment is applicable. Furthermore, when the management server 50 updates the failure information, the same process as the first embodiment is applicable by notifying the control server 10 of the failure information updated by the management server 50.

System

The components illustrated in the drawings do not always need to be physically configured in the manner illustrated in the drawings. That is, the components may be distributed or integrated in arbitrary units. Furthermore, for each processing function performed by each apparatus, all or any part of the processing function may be implemented by a CPU and a program analyzed and executed by the CPU or may be implemented as hardware by wired logic.

Moreover, of the processes described in the embodiments, all or part of a process described as being performed automatically may also be performed manually. Alternatively, all or part of a process described as being performed manually may also be performed automatically by known methods. In addition, the processing procedures, control procedures, specific names, and information including various kinds of data and parameters illustrated in the above-described document and drawings may be arbitrarily changed unless otherwise specified.

Hardware

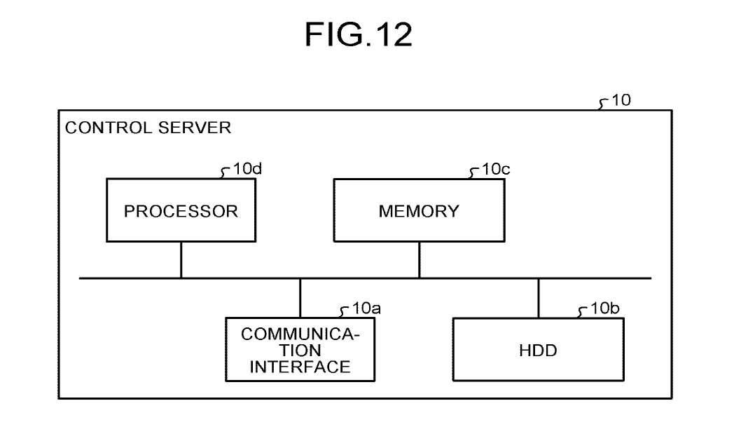

FIG. 12 is a diagram illustrating an example of a hardware configuration. In the following, the control server 10 will be described as an example, but the same applies to the management server 50. As illustrated in FIG. 12, the control server 10 includes a communication interface 10a, a hard disk drive (HDD) 10b, a memory 10c, and a processor 10d. Furthermore, the components illustrated in FIG. 12 are connected to one another via a bus or the like.

The communication interface 10a is an interface that controls communication with other apparatuses, and is, for example, a network interface card. The HDD 10b stores therein programs and DBs for implementing the functions illustrated in FIG. 1 or the like.

The processor 10d reads a program that executes the same processes as those performed by the processing units illustrated in FIG. 2 or the like from the HDD 10b or the like, loads the programs on the memory 10c, and runs the processes that implement the functions described with reference to FIG. 2 or the like.

That is, the processes implement the same functions as those of the processing units included in the control server 10. Specifically, the processor 10d reads a program with the same functions as those of the updating unit 21, the condition determining unit 22, and the notifying unit 23 from the HDD 10b or the like. Then, the processor 10d performs the processes that execute the same processes as those performed by the updating unit 21, the condition determining unit 22, and the notifying unit 23.

As described above, the control server 10 functions as an information processing apparatus that performs a management method by reading and executing the program. Furthermore, the control server 10 can implement the same functions as those of the above-described embodiments by reading the above-described program from a recording medium by a medium reading device and executing the read program. Incidentally, the program described in this embodiment does not necessarily have to be executed by the control server 10. For example, the present invention is applicable to a case in which other computers or servers execute the program or in which other computers and serves execute the program in cooperation with each other.

According to the embodiment of the present invention, it is possible to improve the reliability of a system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management apparatus comprising:
a memory that stores therein configuration information on a system that operates in each of data centers; and
a processor that is connected to the memory, wherein the processor executes a process including:
specifying, from the memory, a data center having configuration information on the system that meets a condition under which a failure occurs; and
transmitting failure information relating to the failure to a notification destination of the data center specified at the specifying.

2. The management apparatus according to claim 1, wherein
the memory further stores therein regional information for specifying a region in which each of the data centers is installed, and
the transmitting includes controlling transmission of the failure information in accordance with the regional information associated with the specified data center.

3. The management apparatus according to claim 2, wherein when a region specified by the regional information is subjected to export control, the transmitting includes suppressing transmission of the failure information.

4. The management apparatus according to claim 2, wherein when a region specified by the regional information is subjected to export control, the transmitting includes transmitting part of the failure information.

5. The management apparatus according to claim 2, wherein when a region specified by the regional information is subjected to export control, the transmitting includes transmitting the failure information to a notification destination associated with an administrator in a region that is not subjected to the export control among administrators in the specified data center.

6. A management method comprising:
referring to a memory that stores therein configuration information on a system that operates in each of data centers, using a processor;
specifying, from the memory, a data center having configuration information on the system that meets a condition under which a failure occurs, using the processor; and
transmitting failure information relating to the failure to a notification destination of the data center specified at the specifying, using the processor.

7. A non-transitory computer-readable recording medium having stored therein a program that causes a computer to execute a process comprising:
referring to a memory that stores therein configuration information on a system that operates in each of data centers;
specifying, from the memory, a data center having configuration information on the system that meets a condition under which a failure occurs; and
transmitting failure information relating to the failure to a notification destination of the data center specified at the specifying.
